(19) United States
(12) Patent Application Publication
(10) Pub. No.: US 2016/0246880 A1
(43) Pub. Date: Aug. 25, 2016

(54) ACHIEVEMENT AND RECOGNITION SYSTEMS AND METHODS

(71) Applicants: Rami BATTIAH, Rochester, NY (US); Abdullah BINAFIF, Richardson, TX (US); Fahad ALBESHRI, Urbana, IL (US); Samah BALKHAIR, Rochester, NY (US)

(72) Inventors: Rami BATTIAH, Rochester, NY (US); Abdullah BINAFIF, Richardson, TX (US); Fahad ALBESHRI, Urbana, IL (US); Samah BALKHAIR, Rochester, NY (US)

(21) Appl. No.: 14/625,695

(22) Filed: Feb. 19, 2015

(51) Int. Cl. G06F 17/30; G09B 5/02

(52) U.S. Cl. CPC G06F 17/30864; G09B 5/02

(57) ABSTRACT

Achievement-posting systems, methods, and computer-readable media which include or use a registration component that receives user registrations for multiple social media websites via a communications interface. A goal component receives a user goal via the communications interface, and a measurement component records one or more accomplishments of a user towards the user goal. A milestone component displays the recorded one or more accomplishments of the user via the communications interface. A support component downloads incoming content from other registrants, a tagging component tags the incoming content according to pre-established privacy parameters, and an achievement component posts completion of the user goal.

### BACKGROUND

1. Grant of Non-Exclusive Right

This application was prepared with financial support from the Saudi Arabian Cultural Mission, and in consideration therefore the present inventor(s) has granted The Kingdom of Saudi Arabia a non-exclusive right to practice the present invention.

2. Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Social websites provide a mechanism to post content, including media content to a website for others to view, either as an invited guest or member or without invitation. The posted content can cover a very wide spectrum of subject matter, and the posted content may not be validated in any way. Therefore, there is a lack of validation or merit to many social websites. In addition, there are many different independent social web sites in which desired content can be found.

### SUMMARY

In one embodiment, a computer-implemented method of posting a plurality of events includes receiving through a communications interface of a processor from a user privacy parameters for a plurality of categories and a plurality of sub-categories of the plurality of events. The method also includes receiving through the communications interface a tagged first event having one or more categories and one or more sub-categories tagged with privacy parameters, and forwarding via circuitry the tagged first event to a first external documentation system. The method also includes receiving through the communications interface a downloaded second event from a second external documentation system, and tagging via the circuitry of the processor the downloaded second event with one or more categories and one or more sub-categories. The method also includes posting via the circuitry of the processor at least one of the tagged first and second events according to the categories and the sub-categories, with the privacy parameters restricting accessibility of the posted first and second events.

In one embodiment, a computerized achievement-posting system for registrants includes a registration component configured by programming and circuitry to receive registrations from the registrants and to allow data to be received from a plurality of external documentation systems. The system also includes a goal component configured by the programming and the circuitry to receive a user goal, and a measurement component configured by the programming and the circuitry to record one or more accomplishments of a user towards the user goal. The system also includes a milestone component configured by the programming and the circuitry to display the recorded one or more accomplishments of the user. The system also includes a support component configured by the programming and the circuitry to download incoming content from the registrants in support of the displayed and recorded one or more accomplishments. The system also includes a tagging component configured by the programming and the circuitry to tag the incoming content according to pre-established privacy parameters, and an achievement component configured by the programming and the circuitry to upload and post said content in conjunction with completion of the user goal.

In one embodiment, a computerized achievement posting system includes a goal component configured by programming and circuitry to receive a user goal. The system also includes a measurement component configured by the programming and the circuitry to record one or more accomplishments of a user towards the user goal, and a categorization index component configured by the programming and the circuitry to index a plurality of documented events pertinent to the user goal. The system also includes a privacy operating standard component configured by the programming and the circuitry to assign privacy standard categories for posting the plurality of documented events, and a downloading communication stream component configured by the programming and the circuitry to receive downloaded content associated with the user goal from other documentation systems via a first real-time communications server. The system also includes an uploading communication stream component configured by the programming and the circuitry to post said content associated with the user goal to one or more external documentation systems via a second real-time communications server, and a search engine component configured by the programming and the circuitry to retrieve indexed results in response to a query.

The foregoing paragraphs have been provided by way of general introduction, and are not intended to limit the scope of the following claims. The described embodiments will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a block diagram illustrating a computerized achievement-posting system for registrants according to one embodiment;

FIG. 2 is an exemplary home page snap shot according to one embodiment;

FIG. 3 is a table illustrating some snap shot features according to one embodiment;

FIG. 4 illustrates time and calendar views for achievement points according to one embodiment;

FIGS. 5A-5C illustrate snap shots for establishing and monitoring a user-defined goal according to one embodiment;

FIG. 6 is a flowchart illustrating an exemplary method of posting a plurality of events according to one embodiment;

FIG. 7 illustrates a computerized achievement posting system according to one embodiment;

FIG. 8 illustrates a computing device according to one embodiment;

FIG. 9 illustrates an exemplary snapshot according to one embodiment;

FIGS. 10A-10B illustrate exemplary snapshots according to one embodiment; and

FIGS. 11A-11B illustrate exemplary snapshots according to one embodiment.

### DETAILED DESCRIPTION OF THE EMBODIMENTS

Embodiments of the invention herein below describe multiple achievement and recognition systems and methods. Various achievement and recognition systems and methods of the invention described below create a place to encourage individuals, teams, groups, and family members to post and archive their achievements and be encouraged from others. In addition, the various systems and methods of the invention described below can help parents, organizations, schools, and governments to discover talented individuals by seeing their accomplishments from multiple perspectives and to build upon them.

One social recognition system includes documented and indexed accomplishments for an individual, group, school, or organization, which is accessible to approved viewers. The accomplishments could be ranked or attributed a numerical value. Another system includes an algorithm configured to organize, search, and archive events and accomplishments by one or more of date, subject matter, organization, activity, and genre. A method of documenting and posting a plurality of events or accomplishments includes tagging an event by one or more categories and one or more sub-categories, establishing privacy parameters for each of the one or more categories and the one or more sub-categories, and posting the plurality of events or accomplishments according to the categories, sub-categories, and privacy parameters.

There may be certain sub-categories of a category the user would like to share with anyone and other sub-categories the user would like to specify who has viewing rights. For example, one sub-category could be open for public viewing, another sub-category could be open for viewing to friends and team members only, and yet another sub-category could only be viewed by specifically-named friends and/or team members. An example will be given for illustrative purposes only. The category could be “My job.” Sub-category A could be called “Where I Work,” and is open for public viewing. Sub-category B could be called “Promotions Received,” which can only be viewed by friends and team members. Sub-category C could be called “Resume,” which can only be viewed by one or more specifically-named friends and/or team members. Once privacy parameters have been established by a user for various categories and their associated sub-categories, the applicable privacy parameters will be assigned to all events that are tagged with a particular sub-category. With reference to the example given above, a future event may be received and tagged as Category-My Job and Sub-Category-Promotions Received. The tagged event will automatically be assigned with privacy parameters of being viewed by friends and team members only.

An event documentation system includes a categorization index for a plurality of events, a privacy operating standard for core categories, and a database for storage of documents, videos, and photographs. The event documentation system also includes an uploading communication stream configured to post events to other documentation systems, a downloading communication stream configured to receive events from other documentation systems, a search engine, and an archival index. An event and achievement blog includes an introductory section containing basic facts about the blog owner, one or more group sections containing facts and member names of the associated group, and a calendar section containing future events. The event and achievement blog also includes a posting section configured to receive and post data received from the blog owner and other blogger individuals according to established privacy standards, and circuitry configured to send and receive an event or achievement to and from other blogs.

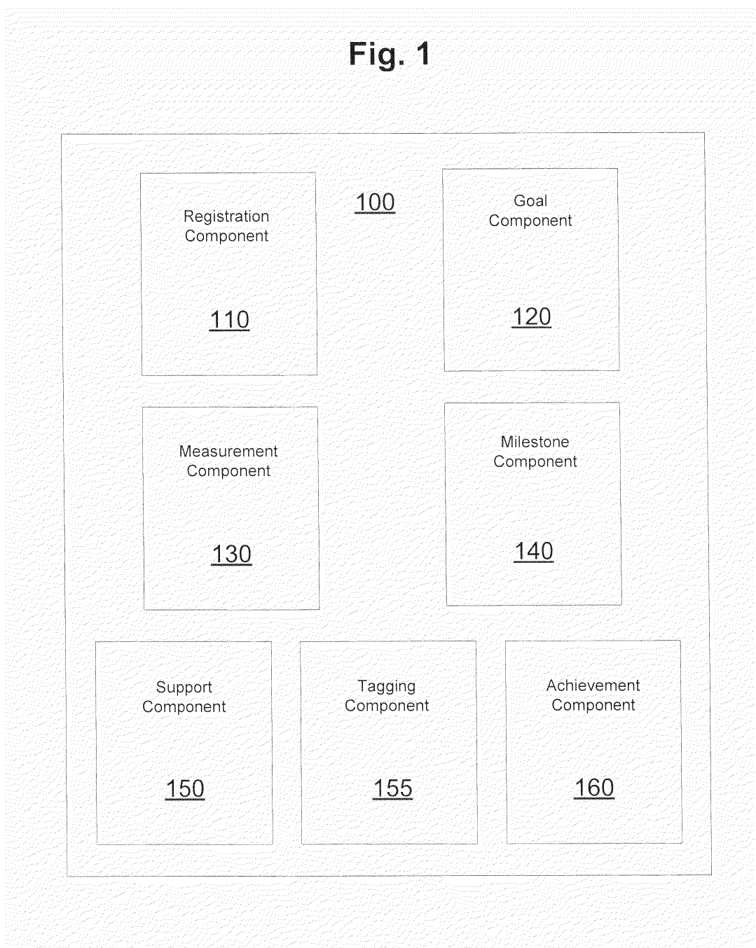

FIG. 1 is a block diagram illustrating a computerized achievement-posting system for registrants 100. FIG. 1 is a simple overview of the multiple components of system 100. However, multiple hardware components can be integrated together with the illustrated components of FIG. 1. Specific hardware components mentioned in embodiments herein could be referencing the same physical hardware component used throughout, or it could be referencing different but similar hardware components being used with multiple other components.

FIG. 1 includes a registration component 110 that is configured by programming and circuitry to receive registrations from the registrants and to allow data to be received from a plurality of external documentation systems. A user can register his/her email accounts, as well as multiple social website accounts into a single conglomerate account. The user can send and receive electronic correspondence to and from the registered accounts under the auspices of the single conglomerate account. This has the clear advantage of a central location to check, send, and receive electronic correspondence without the need to check each account individually.

A user can set up his/her conglomerate account with a profile page, which could include personal bio information for an individual, along with one or more photographs. A group or organization user could include general group information, such as a general description of the group, its purpose or objectives, its location(s), and its membership. One or more photographs, either actual or illustrative can also be included. In an embodiment, the one or more registrants or the user could comprise a group of individuals.

FIG. 1 also includes a goal component 120 configured by the programming and the circuitry to receive a user goal. A user can add one or more goals to his/her profile. The goal can include a goal name, a category, a start and end date, and various checkpoints in which to achieve the defined goal. The conglomerate account provides the user with ways to check progress, adjust any checkpoints, and present reminders associated with the due dates for the checkpoints. As an example, a defined goal could be losing thirty pounds by the end of six months. A set of reminders could include a weekly reminder to reach a five-pound weight loss by the end of each of the six months.

FIG. 1 also includes a measurement component 130 configured by the programming and the circuitry to record one or more accomplishments of a user towards the user goal. In the example given above for a goal to lose thirty pounds by the end of six months, the measurement component 130 could provide regular measurements or recordings pertinent to the goal, such as a daily weight recording. Other pertinent measurements could be body measurements such as a waistline measurement, an exercise routine, or specific dietary implementations.

FIG. 1 also includes a milestone component 140 configured by the programming and the circuitry to display the recorded one or more accomplishments of the user. Continuing with the weight loss goal described above, the recorded measurements from the measurement component 130 could be posted by the milestone component 140. This provides the benefit of an accountability record of the user to other registrants in the conglomerate account. In an embodiment, a point system could also be utilized. For example, ten points could be awarded for achieving a milestone mark, twenty points could be awarded for exceeding the milestone mark, no points could be awarded for missing the milestone mark, and negative points could be awarded if negative progress is made. Titles could also be associated with major milestones that are reached towards achieving the defined goal.

FIG. 1 also includes a support component 150 configured by the programming and the circuitry to download incoming content from the registrants in support of the displayed and recorded one or more accomplishments. The support component 150 provides a positive boost of support from other registrants of the conglomerate account when an achievement is reached or surpassed. It can also provide constructive support and encouragement from other conglomerate account users when an achievement is not reached. The feeds received from other registrants can be reviewed several times throughout the life of a goal to provide continued encouragement. In an embodiment, registrants of a conglomerate account can share their goals with other registrants to encourage and support them towards accomplishing the same or similar goals. In another embodiment, the downloaded incoming content of the support component could include a chat session.

FIG. 1 also includes a tagging component 155 configured by the programming and the circuitry to tag incoming content according to pre-established privacy parameters. An embodiment of pre-established privacy parameters includes, but is not limited to different security levels, such as content available to the public, content available to friends only, and content available only to specifically-named entities.

FIG. 1 also includes an achievement component 160 configured by the programming and the circuitry to upload and post said content in conjunction with completion of the user goal. The achievement component 160 marks final completion of the defined user goal. This usually marks a time of celebration and a sense of accomplishment. The achievement component 160 could include many sub-components, including but not limited to a “more than usual” display of accomplishment and positive support from other user registrants of the conglomerate account, a reward in the form of money, title, or presentation, a physical or electronic plaque of the specific achievement, or an album of the progression of the defined user goal. A time release of congratulatory presentations could also be a sub-component of the achievement component 160 for a particular defined user goal.

Examples of a group user achievement component 160 could include, but are not limited to winning a contest which entails monetary or other rewards, meeting a particular deadline, winning a particular decision, winning a sporting championship, or serving a particular number of targeted individuals. Acknowledgement of the achievement could be captured in numerous external documentation systems, as well as a fully documented internal profile for the users of the conglomerate account. The achievement component 160 for a group could also recognize individual contributions of its membership.

The achievement component 160 could also be used to present and recognize previous accomplishments of a user or group. An example in which historical accomplishments could be used is an individual retirement.

A challenge component could also be included in the computerized achievement-posting system for registrants 100. In one embodiment, the challenge component is configured by the programming and the circuitry to receive a challenge from one or more of the registrants to meet a new goal or exceed an existing user defined goal. As an example, given for illustrative purposes only, a user may have mentioned on different occasions a desire to run a five-mile race. A challenge can be presented to the user by other registered users of the conglomerate account to run at a particular five-mile race that is scheduled for three months therefrom. The other registered users could simply present the goal of running in the five-mile run, or they could also present one or more milestones in which to achieve the goal.

Another example of a challenge component is configured by the programming and the circuitry to solicit a challenge from the user to one or more of the registrants to participate in achieving a new goal or exceeding an existing goal. As an example, given for illustrative purposes only, a user may have recently met his/her goal of running in a five-mile race, and would like to challenge and encourage other registered users to define the same goal for themselves. The user could simply make the challenge of the goal itself, or the user could also offer one or more milestones in which the other registered users could achieve this goal.

A coaching component could also be included in the computerized achievement-posting system for registrants 100. The coaching component is configured by the programming and the circuitry to provide input, advice, and encouragement from the user to one or more of the registrants in achieving their established goals. In one embodiment, a user can be defined as a coach when he/she has attained a minimum score in achieving his/her own defined goal(s) in a particular field or area. For example, a user can establish “coach” as a defined goal. Various milestones can be established by the user, and the user would subsequently be “graded” or evaluated upon completion of those milestones. A combined score or grading system of the coach goal would determine if and when the user obtained the final goal of becoming a coach. Other criteria could also be used to define a user as a coach including, but not limited to previous documented experience, a degree or certificate in the particular field or area, and references or recommendations from other established individuals in the particular field or area. One or more of these criteria could be used in addition to the point system previously described or in lieu of the point system.

Another example of a coaching component is configured by the programming and the circuitry to post a request from the user to one or more of the registrants for coaching assistance in achieving a user-defined goal. Coaching assistance could be desired when the user feels the need for an experienced person to help guide him/her through a process towards a defined goal. The coaching assistance could be in the form of knowledge and advice of the relevant field, management of milestones, moral support and encouragement, and to provide an assessment of progress and to advise of any adjustments that might be deemed necessary. These and other coaching roles could be indicated in a user's request for a coach. A user could also request more than one coach. The additional coach request(s) could be for a different type or a different subject area of coaching assistance the user feels would be helpful in achieving his/her defined goal. The additional coach request could also be a request to replace an existing coach for reasons deemed necessary by either the user or the existing coach.

An archive component could also be included in the computerized achievement-posting system for registrants 100. The archive component has programming and circuitry configured to record, index, and archive content and documented achievements for subsequent reference. One advantage of embodiments described herein is a documentation of achievements, rather than a simple statement of achievement. The documentation is saved and indexed with the associated components illustrated in FIG. 1. A single achieved goal or a group of achieved related goals can be indexed together into an album for future reference.

In addition, an archived album can be supplemented with future related goals. In another embodiment, a point-award component is configured by programming and circuitry to award one or more points to the one or more accomplishments and to the user goal.

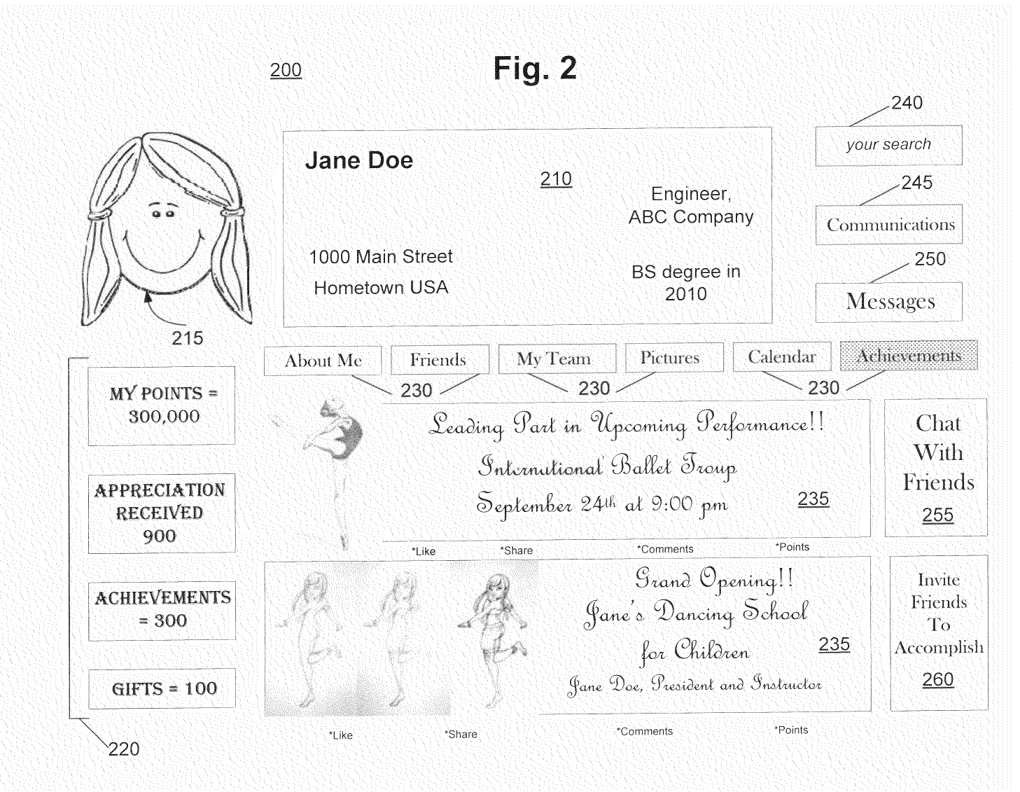

FIG. 2 is an exemplary home page snap shot 200 for a user of a computerized achievement-posting system for registrants according to one embodiment of the invention. Other user registrants could view general information 210 about Jane Doe, including but not limited to her address, her occupation and current employer, at least one degree earned, and a portrait picture 215. The left portion of FIG. 2 illustrates several achievement-related blocks 220 for Jane Doe. Achievement-related blocks 220 include but are not limited to the total number of achievement points earned to date, e.g. “my points=300,000.” The total number of achievement points could be earned from a myriad of programs, including but not limited to milestones reached, challenges met, challenges offered, coaching, and reaching a defined goal. In addition, each type of goal could have its own custom point system.

Another achievement-related block 220 is “appreciation received.” Points in this block could be earned from other user registrants showing appreciation for a user's accomplishments, which are translated into points from an established appreciation point system. As an example, 50 points could be awarded for each achievement. A total number of achievements could also be displayed, as well as any gifts that were donated or given by other user registrants.

Several links or drop-down menus 230 could be included on the home page snap shot 200, including but not limited to “about me,” “friends,” “my team,” “pictures,” “calendar,” and “achievements.” The “achievement” link 230 has been selected in FIG. 2, in which two exemplary achievements 235 are displayed. Other links are illustrated in FIG. 2, including a search box 240, a communications box 245, and a message box 250. FIG. 2 also illustrates a chat box 255 and an invitation box 260. Other features that could be included in the home page snap shot 200 are a listing of the user's top achievement point-earning friends. The list of point-earning friends could be listed in descending order of points achieved or alphabetically, as well as other preferred orders of arrangement.

The search box 240 could be used to find particular goals and achievements of a user or other users. The achievements could also be searched in the search box 240 by name, date, category, etc. The communications box 245 could be used to interact with others via messaging, chat, and/or invitations. A message box 250 is used to view received messages. A chat box 255 can be used to send or receive a chat session with one or more users. An invitation box 260 can be used to invite friends to accomplish a particular goal.

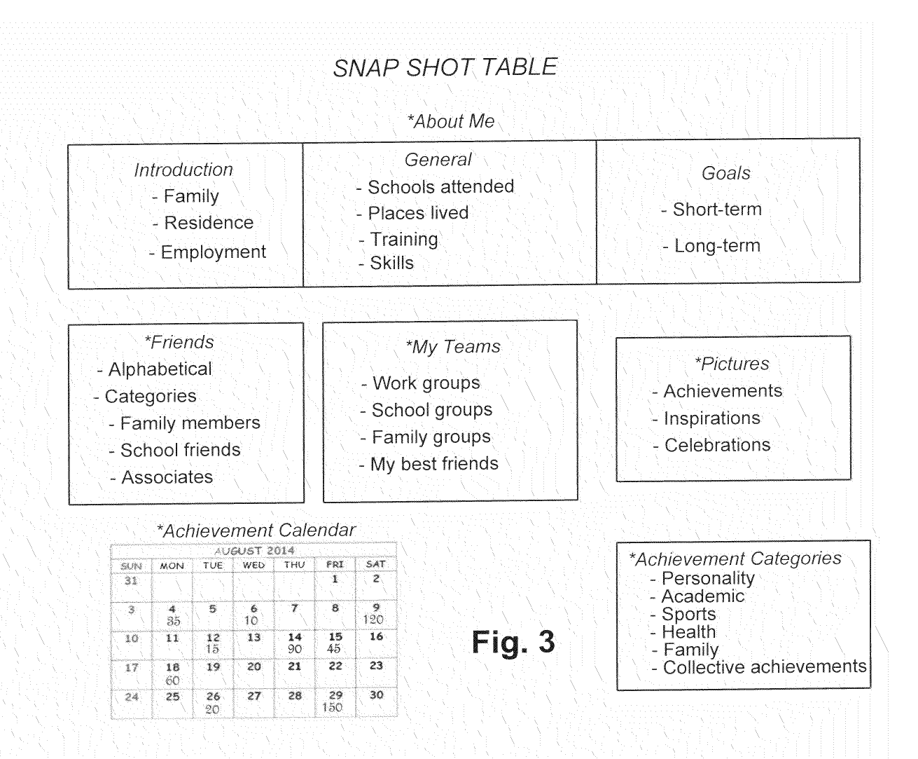

FIG. 3 is a table illustrating some of the snap shot features of FIG. 2 in more detail. The drop-down menus 230 include “about me,” which could include an introduction of the user, and could also include the user's family, current place of employment or study, and current location of residence. Other information that could be included is previous or current schools attended, places previously lived or visited, any special training or skills, or any short-term or long-term objectives. “About me” could include any information the user wishes to display about himself or herself.

With reference back to FIG. 2, another drop-down menu 230 is “friends.” This drop-down menu could be further categorized as to the type of friends, such as family, school friends, and previous or current associates. Another embodiment includes an alphabetical listing of friends.

Another drop-down menu 230 is “my team.” This could be categorized into the different teams in which the user participates. One exemplary listing of teams could be based upon the type of goal, such as health, education, or social. Another exemplary listing of teams could be based upon the primary interest or occupation of its members.

Another drop-down menu 230 is “pictures.” This could include any type and number of pictures the user wishes to share with other users. The “pictures” drop-down menu 230 could be categorized into multiple albums in one embodiment.

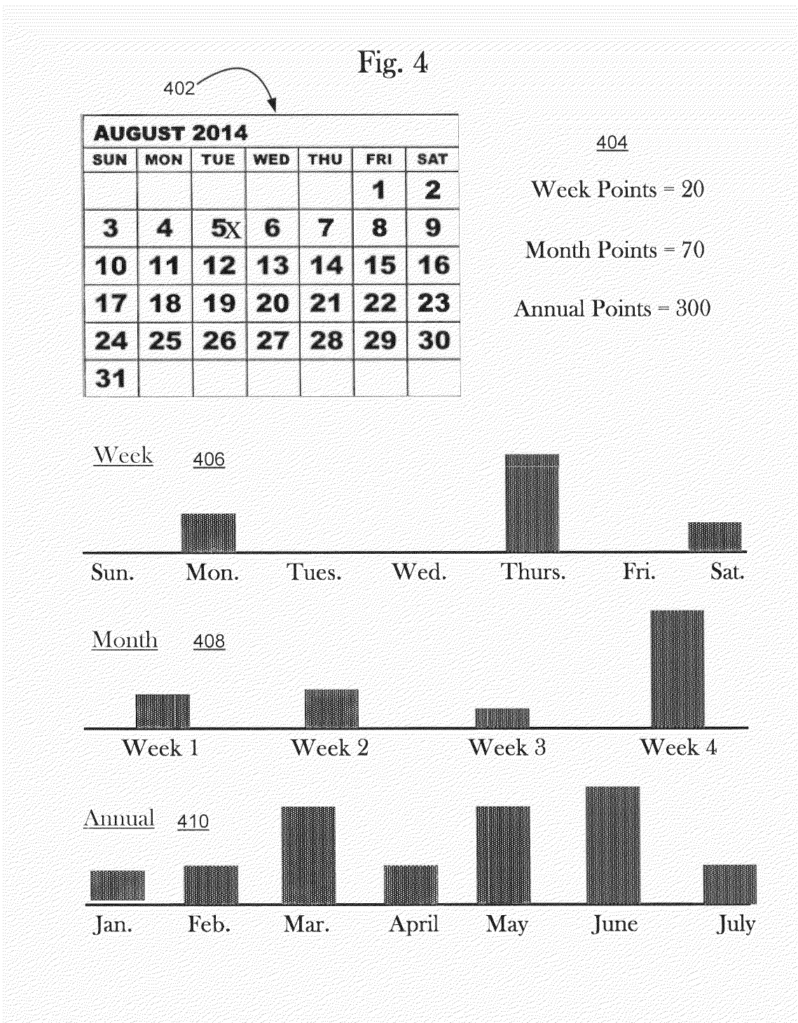

Another drop-down menu 230 is “calendar,” which indicates a number of points earned over time. FIG. 4 illustrates time views 406, 408, 410 and calendar view 402 for achievement points of a user, shown in point totals 404. As of a particular day of the year, illustrated in FIG. 4 as Aug. 5, 2014, the user has accumulated 20 weekly points, 70 monthly points, and 300 annual points. Graphs of the time views 406, 408, 410 are also given to illustrate where the points were earned in terms of a weekly view, a monthly view, and an annual view up to the current date.

With reference back to FIG. 3, the “achievements” drop-down menu 230 describes some possible categories in which “achievements” can be divided, including but not limited to personality, sports, academic, health, family, and collective achievements. When the “achievements” drop-down menu 230 is selected, the most recent achievements could be automatically displayed, such as the two achievements 235 illustrated in FIG. 2. A time line could also be illustrated for achievements earned with the most recent appearing first.

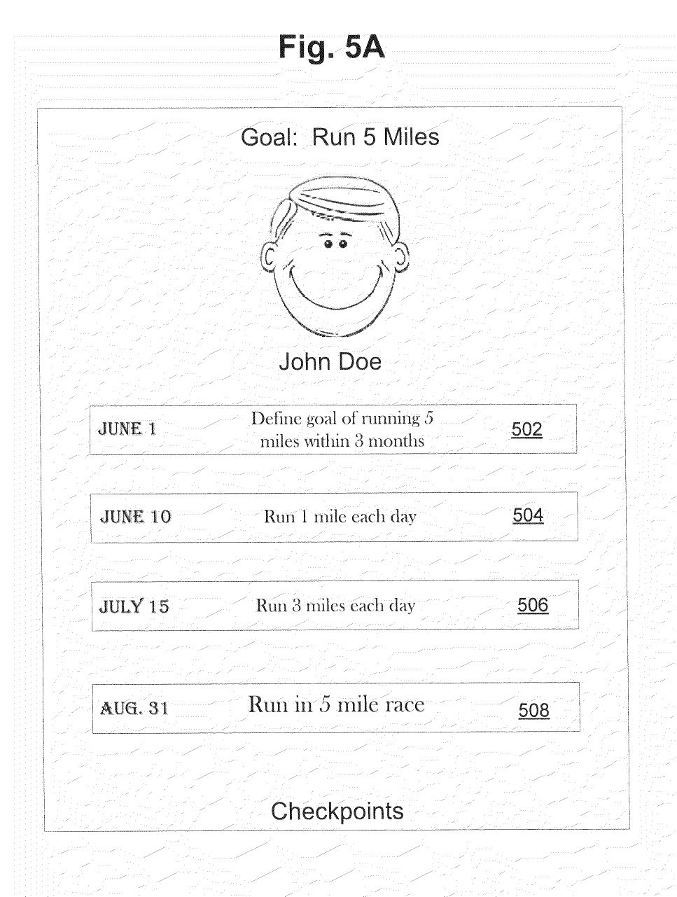

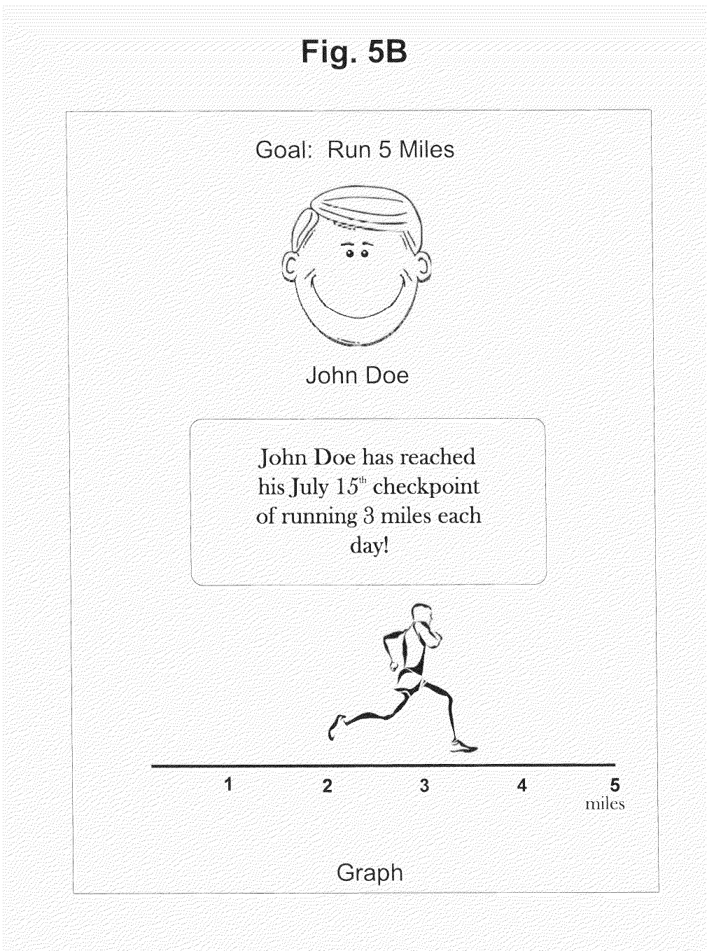

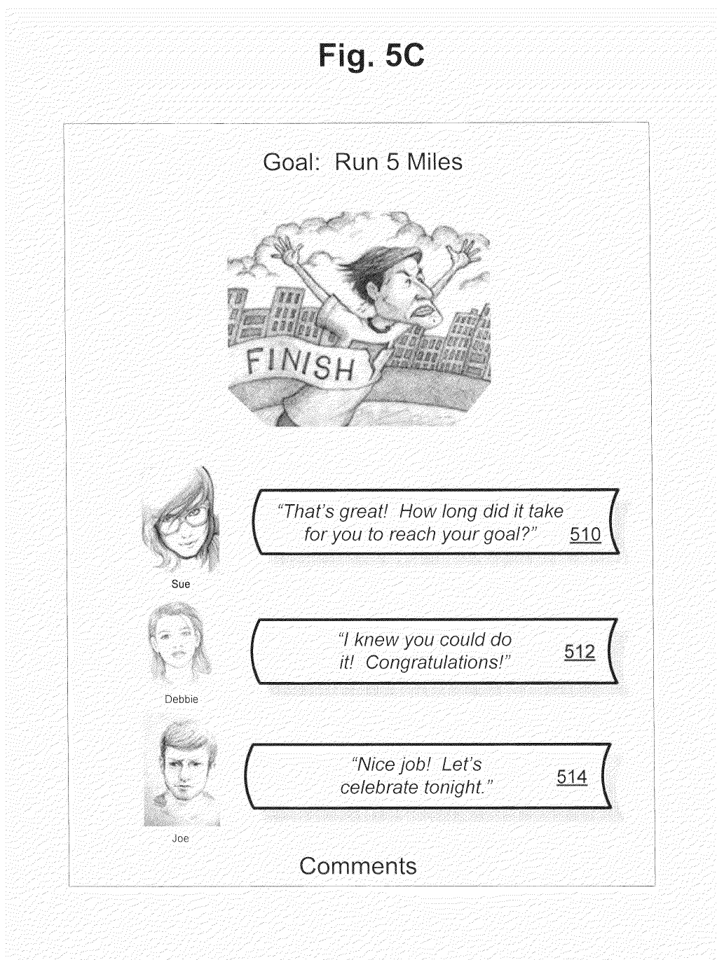

FIGS. 5A-5C illustrate snap shots for establishing and monitoring a user-defined goal. FIG. 5A illustrates multiple exemplary checkpoints 502, 504, 506, and 508 for John Doe to reach a goal. On June 1^{st}, John defined a goal of running five miles within a three-month period of time for a first checkpoint. A second checkpoint was established for June 10^{th}, wherein John set a milestone of running one mile each day by that date. A third checkpoint was established for July 15^{th} of running three miles each day. By August 31^{st}, John set a final checkpoint for achieving his goal of running in a five-mile race.

FIG. 5B is a graph which illustrates John reaching his third checkpoint of running three miles each day by July 15^{th}. Multiple graphs could be available to show progress achieved at each checkpoint, which could be linked to the checkpoint options of FIG. 5A.

FIG. 5C illustrates John Doe reaching his goal of running in a five-mile race. FIG. 5C also illustrates comments 510, 512, 514 from friends or other users in support and appreciation of John having reached his defined goal. In one embodiment, the comments window could provide a link to directly add points, such as the appreciation points and total points 220 illustrated in FIG. 2. In another embodiment, a chat session could be initiated from the comments window to provide interactive support and appreciation for the user achieving his/her defined goal.

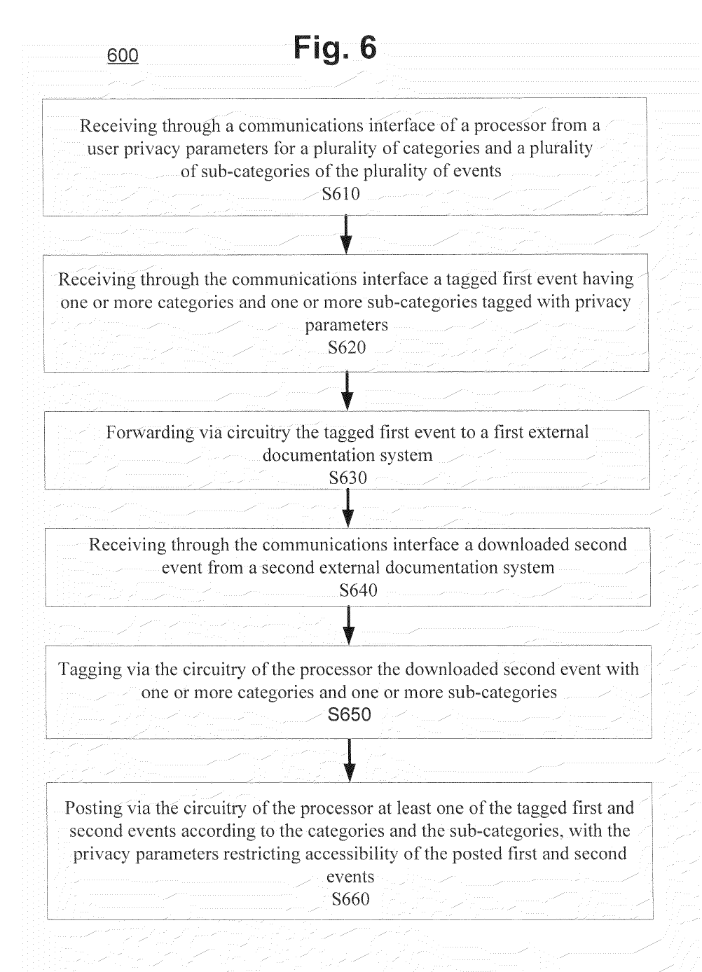

FIG. 6 is a flowchart illustrating an exemplary method 600 of posting a plurality of events. The method includes receiving through a communications interface of a processor from a user privacy parameters for a plurality of categories and a plurality of sub-categories of the plurality of events in step S610. An event could include numerous activities or achievements that a user would like to document and share with other individuals. Category examples of events include, but are not limited to winning a race, receiving a promotion, earning a diploma or degree, achieving a physical milestone, retiring, etc. However, there may be some sub-categories of a category the user would like to share with anyone and other sub-categories the user would only like friends or team members to have viewing rights. Embodiments described herein provide a mechanism in which different privacy parameters can be established for different sub-categories of a category.

Method 600 also includes receiving through the communications interface a tagged first event having one or more categories and one or more sub-categories tagged with privacy parameters in step S620. Any event that is entered or posted under a particular category and sub-category will automatically be governed by previously established privacy parameters for that category and sub-category.

Method 600 also includes forwarding via circuitry the tagged first event to a first external documentation system in step S630, and receiving through the communications interface a downloaded second event from a second external documentation system in step S640. In one embodiment, a first tagged event (i.e. an event tagged with one or more categories and/or sub-categories) can be posted to a user's account from a first social website, and subsequently forwarded or uploaded to a second social website. Conversely, a second event from the second social website can be downloaded to the user's account and subsequently tagged.

Method 600 also includes tagging via the circuitry of the processor the downloaded second event with one or more categories and one or more sub-categories in step S650. In step S660, at least one of the tagged first and second events are posted via the circuitry of the processor according to the categories, sub-categories, with the privacy parameters restricting accessibility of the posted first and second events. Step S650 for tagging via the circuitry of the processor the downloaded second event with one or more categories and one or more sub-categories transforms the downloaded data such that tagged data permits one to post this data in a form which is more readily associated (by a user or another processor reading the data) with the achievements, thus improving the ability of the system to communicate, monitor, and post achievement data without requiring receiving systems to process this data.

The tagging in step S650 could also include identifying via the circuitry of the processor keywords from the downloaded second event, and comparing via the circuitry of the processor each identified keyword to the plurality of categories and the plurality of sub-categories. The tagging could also include determining a match between the one or more keywords and the one or more categories and the one or more sub-categories, and tagging the second event with the matched one or more categories and the matched one or more sub-categories.

In one embodiment, the first external documentation system includes an event blog with the tagged first event. In another embodiment, the received downloaded second event is posted to the event blog. In still another embodiment, the received downloaded second event is received from a different individual, group, school, or organization associated with the tagged first event.

The first and second events can include ranked documented accomplishments for an individual, group, school, or organization, as examples. The ranked documented accomplishments include, but are not limited to exceeding an established record, a public presentation of an award, a certificate of completion, a completed course of study, a publicized promotion, a completed sale of a product or service, a level of publicly received funds, or winning a publicly-awarded prize. Other documented accomplishments would be apparent to a person of ordinary skill in the art. The tagging could also include receiving from the user a privacy-right designation for the second event.

Method 600 could also include receiving a ranking or a number of awarded points for the ranked documented accomplishments. In one embodiment, the ranking could be based upon a standardized scale of accomplishments. Method 600 could also include archiving via a storage database the ranked documented accomplishments by one or more of date, subject matter, organization, activity, and genre.

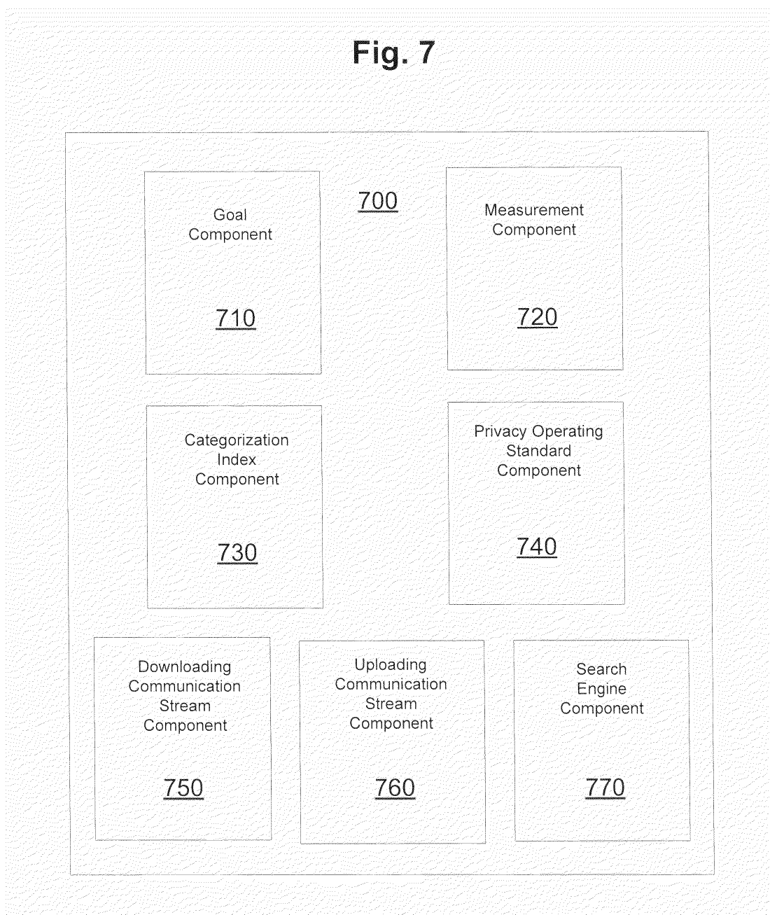

FIG. 7 illustrates a computerized achievement posting system 700 according to one embodiment of the invention. The achievement posting system 700 includes, but is not limited to one or more of a family achievement system, an educational achievement system, a religious organizational achievement system, a musical achievement system, or an athletic achievement system. FIG. 7 is a simple overview of the multiple components of achievement posting system 700. However, it would be understood by persons of ordinary skill in the art that multiple hardware components are integrated together with the illustrated components of FIG. 7. Specific hardware components mentioned in embodiments herein could be referencing the same physical hardware component used throughout, or it could be referencing different but similar hardware components being used with multiple other components.

Achievement posting system 700 includes a goal component 710 configured by programming and circuitry to receive a user goal. A user can add one or more goals to his/her profile. The goal can include a goal name, a category, a start and end date, and various checkpoints in which to achieve the defined goal. The conglomerate account provides the user with ways to check progress, adjust any checkpoints, and present reminders associated with the due dates for the checkpoints. As an example, a defined goal could be losing thirty pounds by the end of six months. A set of reminders could include a weekly reminder to reach a five-pound weight loss by the end of each of the six months.

Achievement posting system 700 also includes a measurement component 720 configured by programming and circuitry to record one or more accomplishments of a user towards the user goal. In an example for a goal to lose thirty pounds by the end of six months, the measurement component 720 could provide regular measurements or recordings pertinent to the goal, such as a daily weight recording. Other pertinent measurements could be body measurements such as a waistline measurement, an exercise routine, or specific dietary implementations.

Achievement posting system 700 also includes a categorization index component 730. The categorization index component 730 has programming and circuitry configured to index a plurality of documented events pertinent to the user goal. Achievement posting system 700 also includes a privacy operating standard component 740. The privacy operating standard component 740 has programming and circuitry configured to assign privacy standard categories for posting the plurality of documented events. Privacy standards can be assigned for a plurality of categories and a plurality of associated sub-categories.

Achievement posting system 700 also includes a downloading communication stream component 750. The downloading communication stream component 750 has programming and circuitry configured to receive downloaded content associated with the user goal from other documentation systems via a first real-time communications server. Content from other systems could include documented achievements, awards, articles, etc. that are posted to a user's account in support of an achievement of the user. The content could be directly related to the user or it could be directed to another individual that might be an inspiration to the user.

Achievement posting system 700 also includes an uploading communication stream component 760. The uploading communication stream component 760 has programming and circuitry configured to post said content associated with the user goal to one or more external documentation systems via a second real-time communications server. Achievements of the user could be posted to other documentation systems, or the user might post content to another user's account as a possible inspiration or encouragement to the other user.

Achievement posting system 700 also includes a search engine component 770. The search engine component 770 has programming and circuitry configured to retrieve indexed results in response to a query. The search engine component 770 could work in conjunction with the categorization index component 730 to locate and display requested information to a user.

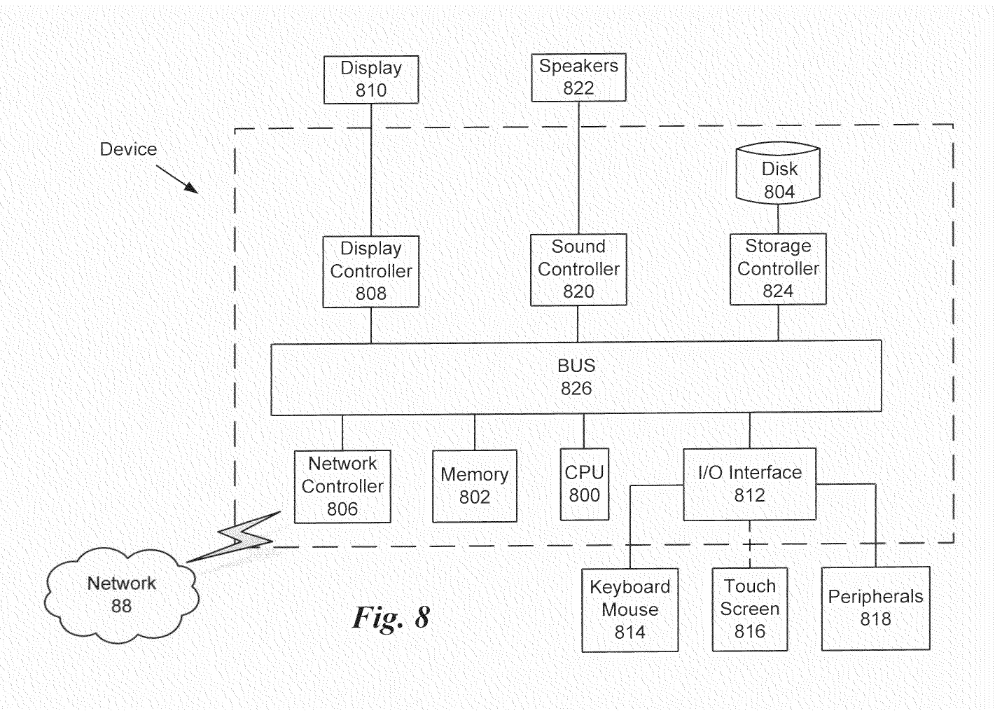

A hardware description is given with reference to FIG. 8 for a computing device, such as the processors, databases, and servers used in conjunction with associated circuitry for embodiments described herein. This circuitry represents hardware and software components whereby the “configured by circuitry,” “configured by programming and circuitry,” and/or “configured to” elements of the invention noted above are programmed. This programming in hardware and software constitutes algorithmic instructions to carry out the various functions and acts noted and described above. In FIG. 8, the computing device includes a CPU 800 which performs the processes described above. The process data and instructions may be stored in memory 802. These processes and instructions may also be stored on a storage medium disk 804 such as a hard disc drive (HDD) or portable storage medium or may be stored remotely. Further, the claimed embodiments are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claimed embodiments may be provided as a utility application, background daemon, or component of an operating system, or combination thereof, executing in conjunction with CPU 800 and an operating system such as Microsoft Windows 7, UNIX, Solaris, LINUX, Apple MAC-OS and other systems known to those skilled in the art.

CPU 800 may be a Xenon or Core processor from Intel of America or an Opteron processor from AMD of America, or may be other processor types that would be recognized by one of ordinary skill in the art. Alternatively, the CPU 800 may be implemented on an FPGA, ASIC, PLD or using discrete logic circuits, as one of ordinary skill in the art would recognize. Further, CPU 800 may be implemented as multiple processors cooperatively working in parallel to perform the instructions of the inventive processes described above.

The computing device in FIG. 8 also includes a network controller 806, such as an Intel Ethernet PRO network interface card from Intel Corporation of America, for interfacing with network 88. As can be appreciated, the network 88 can be a public network, such as the Internet, or a private network such as an LAN or WAN network, or any combination thereof and can also include PSTN or ISDN sub-networks. The network 88 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device further includes a display controller 808, such as a NVIDIA GeForce GTX or Quadro graphics adaptor from NVIDIA Corporation of America for interfacing with display 810, such as a Hewlett Packard HPL2445w LCD monitor. A general purpose I/O interface 812 interfaces with a keyboard and/or mouse 814 as well as a touch screen panel 816 on or separate from display 810. General purpose I/O interface 812 also connects to a variety of peripherals 818 including printers and scanners, such as an OfficeJet or DeskJet from Hewlett Packard.

A sound controller 820 is also provided in the computing device, such as Sound Blaster X-Fi Titanium from Creative, to interface with speakers/microphone 822 thereby providing sounds and/or music. The general purpose storage controller 824 connects the storage medium disk 804 with communication bus 826, which may be an ISA, EISA, VESA, PCI, or similar, for interconnecting all of the components of the computing device. A description of the general features and functionality of the display 810, keyboard and/or mouse 814, as well as the display controller 808, storage controller 824, network controller 806, sound controller 820, and general purpose I/O interface 812 is omitted herein for brevity as these features are known.

The computing devices used with embodiments described herein may not include all features described in FIG. 8. In addition, other features used with embodiments described herein may not be described with reference to FIG. 8.

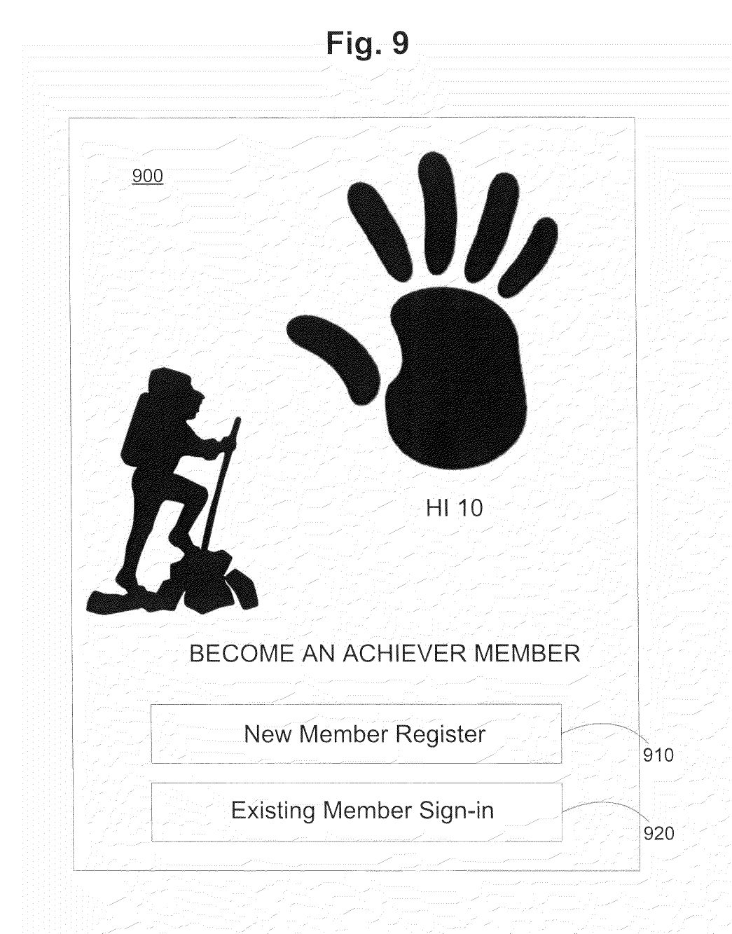

FIG. 9 illustrates an exemplary snapshot 900 of a home screen or login screen for an achievement and recognition system according to embodiments described herein. Entry for registration as a new member 910 is illustrated. After clicking upon a link or icon as a new member 910, follow-up entries will be displayed, such as creating a user identification name or number and a password. A user could also be given the option to sign in using an e-mail address or through another social account. Snapshot 900 also illustrates a sign in link or icon for an existing member 920. Subsequent entries will be displayed for the existing user to enter a user identification and a password. Any new and existing users will also be directed to a user profile creation screen, if a user profile does not already exist.

After signing in, a user has the option of locating other users that are within the achievement and recognition system. An option is also available to directly communicate with other users currently logged into the achievement and recognition system. Top users, as determined by achievement scores and/or other criteria within the network can also be viewed, such as the “Top 10 Users.” An invitation can be extended to people outside of the achievement and recognition system to become an achievement and recognition system member. The invitation could be associated with an achievement previously made by the user, or it could be an invitation to set an achievement as a goal for the invited user.

A timeline of a user's goals and achievements, such as the illustrations of FIGS. 5A-5C can be followed in the achievement and recognition system. The goals and achievements can be designated for the user's viewing only, for viewing by only designated friends, or for public viewing. Posts that are made to a user's account can be viewed in chronological order with the most recent appearing first, or other sorting criteria can be designated.

In a timeline embodiment, individual posting windows can be color coded according to the posting type and state. As an example for illustrative purposes only, a new goal card can be established that displays a goal title, the owner name, an owner thumbnail, a goal cover thumbnail, a number of “Hi 10” designations, and one or more comments. A new goal card can be assigned a specific color or format, such as a blue format. When a user taps one of the cover thumbnails, it can expand to cover the entire area of the card. The user can make a quick “Hi 10” designation or comment, or tap on the card to obtain the goal details.

A checkpoint completed card can be established to display the goal title, the owner name, the owner thumbnail, a checkpoint image thumbnail for a previous checkpoint, a number of “Hi 10” designations, and one or more comments. A checkpoint completed card can be assigned a specific color or format, such as a red format. When a user taps one of the cover thumbnails, it can expand to cover the entire area of the card.

A goal completed card can be established that displays the goal title, the owner name, the owner thumbnail, the latest checkpoint image thumbnail, a number of “Hi 10” designations, and one or more comments. The goal completed card can be assigned a specific color or format, such as a green format. When a user taps one of the cover thumbnails, it can expand to cover the entire area of the card.

An achievement card can be established that displays the title, the owner name, an owner thumbnail, a category, an achievement date, a number of “Hi 10” designations, and one or more comments. The achievement card can be assigned a specific color or format, such as a gold format. If a user adds other users in the achievement, the added users can also be displayed as part of the achievement.

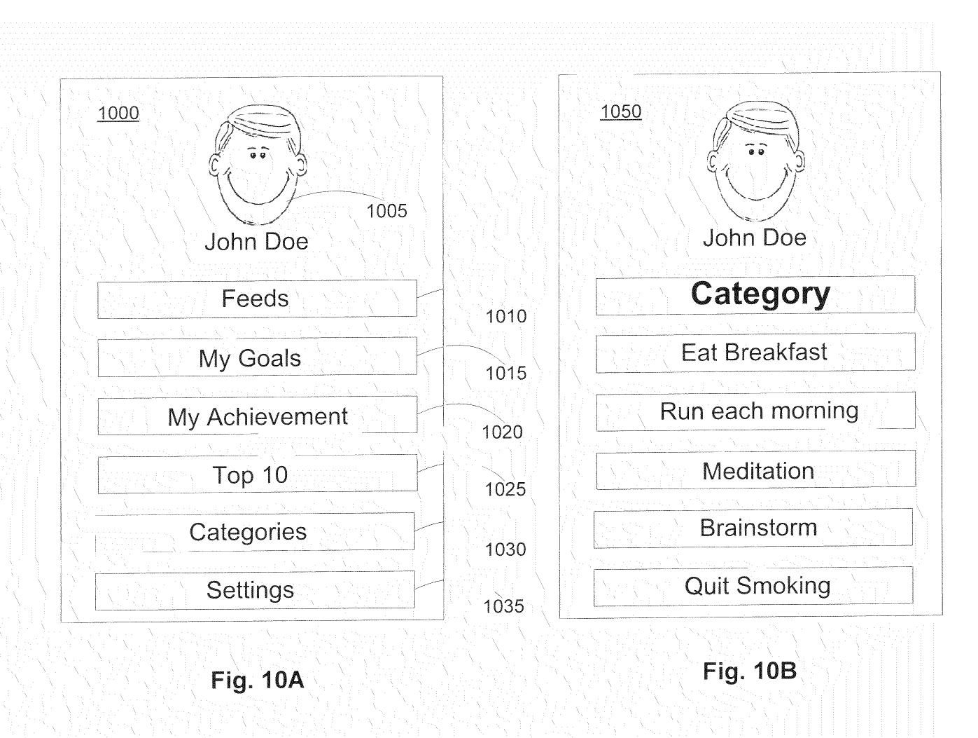

FIG. 10A illustrates an exemplary navigation snapshot 1000 according to embodiments described herein. Snapshot 1000 includes an image 1005 of the user. Tapping or clicking on the image 1005 can navigate the user to a user profile page, where the user profile can be revised. Snapshot 1000 also includes a link or icon for feeds 1010. The feeds 1010 option redirects the user to a timeline page, where various stages of an achievement can be reviewed or edited. A link or icon for goals 1015 redirects the user to a goals page for review or revision. A link or icon for achievements 1020 redirects the user to his/her achievement page for review or revision, or to add a new achievement. A link or icon for “Top 10” 1025 redirects the user to his/her “top 10 user” page for viewing or for previously established guidelines, directions, or hints for a particular achievement. A link or icon for categories 1030 redirects the user to a list of previously established categories. A link or icon for settings 1035 redirects the user to a settings page for review or revision of settings.

FIG. 10B illustrates an exemplary category snapshot 1050, which is an example of a snapshot displayed in response to selecting the categories 1030 icon illustrated in FIG. 10A. An exemplary list of achievement categories are illustrated in FIG. 10B which include, but are not limited to eating breakfast, running each morning, meditation, brainstorming, and to quit smoking. A user can select any category to view its related goals and achievements, which can also be displayed in a timeline view. Each category can display the total number of goals and achievements. A user can add a goal or achievement directly to a certain category. In addition, a user can search for a particular goal or achievement.

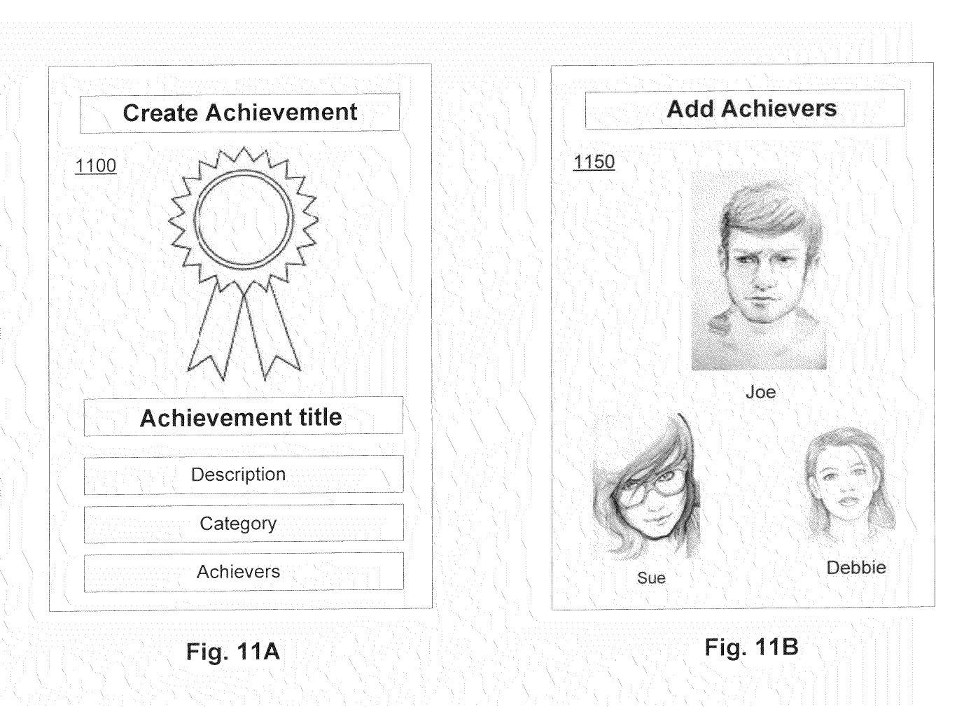

FIG. 11A illustrates an exemplary achievement snapshot 1100, which is an example of a snapshot displayed in response to selecting the achievement 1020 icon illustrated in FIG. 10A. Snapshot 1100 could include the achievement title, a description of the achievement, one or more achievement categories, and a list of other achievers. The other achievers could be people who contributed to the user's achievement, and/or it could be other people with the same or similar established achievements.

FIG. 11B illustrates an exemplary “add achievers” snapshot 1150, which is an example of a snapshot displayed in response to selecting the achievers icon in FIG. 11A. A group achievement can be an achievement the user completed with some of his/her friends. It could also be a common achievement that belongs to everyone.

Other options can be exercised within the achievement and recognition system. One embodiment includes a reminder of the most prominent achievements. As an example, a reminder can be sent to a user after a certain period of time, which shows the best achievements accomplished. This could provide satisfaction and encouragement to the user to accomplish more achievements.

Another embodiment includes hedging previously-earned points. When a user wants to set a goal and commit to achieving that goal, he/she can put a certain number of previously-earned points up for collateral. If the user achieves the goals, the points can be awarded back to the user. If the goal is not achieved, the points can be awarded to someone else previously determined at the onset of the goal. Points can also be awarded for completing and documenting goals and achievements.

Another embodiment includes voting for the best achievements. A user can rank or grade multiple achievements that he/she has accomplished. This can be viewed by friends, which can lead to further reinforcement and engagement with the user. A listing of the most common achievements can also be established amongst users.

Another embodiment includes an option in which the user would like to achieve a particular goal. The user can send a message, video, text message, etc. to a particular person or group of friends to let them know the user has committed towards achieving a particular goal. This is likely to lead to encouragement from those friends, along with specific suggestions, tips, or coaching in line with the committed goal. A wish list can also be established by a user for those goals the user would like to achieve in the future, which could be shared amongst users.

Another embodiment includes an account for parents of an achievement and recognition system user. One or both parents can use the account to document each child's achievements, especially a young child. When the child becomes older, he/she can gradually take over the account for himself/herself.

Embodiments can include various ways in which to celebrate previous achievements. For example, a user can send a short video to his/her friends to announce a particular achievement, as well as encourage them to accomplish similar achievements. A year-end video can also be sent to friends to display the year's achievements of the user. A user can also send an invitation to friends inviting them to a special day to celebrate the user's most important achievements.

Embodiments can include a sharing option when a user is searching for a particular service, such as a coach to assist in accomplishing an achievement. The user can also present himself/herself as a coach to assist others in a particular field.

Another embodiment includes a calendar option, in which a user is reminded of the achievements of others. This provides a reminder to associated friends to post messages or videos of praise and further encouragement to the accomplished user.

The foregoing discussion discloses and describes merely exemplary embodiments of the present disclosure. As will be understood by those skilled in the art, the present disclosure may be embodied in other specific forms without departing from the spirit or essential characteristics thereof. Accordingly, the present disclosure is intended to be illustrative and not limiting thereof. The disclosure, including any readily discernible variants of the teachings herein, defines in part, the scope of the foregoing claim terminology.

Many people make reputable achievements within their lifetimes. However, these tend to be forgotten or the memories diminish with time. As a result, people can become discouraged, thinking they have not achieved a large number or volume of accomplishments. Embodiments described herein can remind people of their achievements, and people can also be encouraged from the achievements of others. The systems and methods described herein provide the mechanisms for people to see and read about their achievements and the achievements of others around them. The systems and methods described herein can be applied to direct personal acquaintances, as well as formal organizations and groups in which there may be no direct contact. The documentation and archiving of individual and group achievements as described herein can motivate and encourage a person or persons to improve their skills and self-esteem for subsequent success. Children's achievements can also be documented, which could assist in building their self-confidence to continue to be successful. It could also be a frequent reminder to parents of their children's achievements.

Generalized aspects of embodiments described herein are set forth below.

The invention in various embodiments includes a computer-implemented method of posting a plurality of events, which includes receiving through a communications interface of a processor from a user privacy parameters for a plurality of categories and a plurality of sub-categories of the plurality of events. The method also includes receiving through the communications interface a tagged first event having one or more categories and one or more sub-categories tagged with privacy parameters, and forwarding via circuitry the tagged first event to a first external documentation system. The method also includes receiving through the communications interface a downloaded second event from a second external documentation system, and tagging via the circuitry of the processor the downloaded second event with one or more categories and one or more sub-categories. The method also includes posting via the circuitry of the processor at least one of the tagged first and second events according to the categories and the sub-categories, with the privacy parameters restricting accessibility of the posted first and second events.

The tagging described above can further include identifying via the circuitry of the processor keywords from the downloaded second event, and comparing via the circuitry of the processor each identified keyword to the plurality of categories and the plurality of sub-categories. The tagging can also include determining a match between the one or more keywords and the one or more categories and the one or more sub-categories, and tagging the second event with the matched one or more categories and the matched one or more sub-categories. The first and second events can include ranked documented accomplishments for an individual, group, school, or organization. The ranked documented accomplishments can include one or more of exceeding an established record, a public presentation of an award, a certificate of completion, a completed course of study, a publicized promotion, a completed sale of a product or service, a level of publicly received funds, or winning a publicly-awarded prize. The tagging can also include receiving from the user a privacy-right designation for the second event.

The method can also include archiving via a storage database the ranked documented accomplishments by one or more of date, subject matter, organization, activity, and genre. The first external documentation system can include an event blog with the tagged first event. The received downloaded second event can be posted to the event blog. The received downloaded second event can be received from a different individual, group, school, or organization associated with the tagged first event.

The invention in other various embodiments includes a computerized achievement-posting system for registrants, which includes a registration component configured by programming and circuitry to receive registrations from the registrants and to allow data to be received from a plurality of external documentation systems. The system also includes a goal component configured by the programming and the circuitry to receive a user goal, and a measurement component configured by the programming and the circuitry to record one or more accomplishments of a user towards the user goal. The system also includes a milestone component configured by the programming and the circuitry to display the recorded one or more accomplishments of the user, and a support component configured by the programming and the circuitry to download incoming content from the registrants in support of the displayed and recorded one or more accomplishments. The system also includes a tagging component configured by the programming and the circuitry to tag the incoming content according to pre-established privacy parameters, and an achievement component configured by the programming and the circuitry to upload and post said content in conjunction with completion of the user goal.

The system can further include a challenge component configured by the programming and the circuitry to receive a challenge from one or more of the registrants to meet a new goal or exceed an existing goal of the user. The system can also include a challenge component configured by the programming and the circuitry to solicit a challenge from the user to one or more of the registrants to participate in achieving a new goal or exceeding an existing goal. The system can also include a coaching component configured by the programming and the circuitry to provide input, advice, and encouragement from the user to one or more of the registrants in achieving their defined goals. The system can also include a coaching component configured by the programming and the circuitry to post a request from the user to one or more of the registrants for coaching assistance in achieving a user-defined goal.

At least one of the registrant or the user in the system described above can include a group of individuals. The downloaded incoming content of the support component can include a chat session. The system can further include a point-award component configured by the programming and the circuitry to award one or more points to the one or more accomplishments and to the user goal. The system can further include an archive component configured by the programming and the circuitry to record, index, and archive content and documented achievements for subsequent reference.

The invention in other various embodiments includes a computerized achievement posting system, which includes a goal component configured by programming and circuitry to receive a user goal, and a measurement component configured by the programming and the circuitry to record one or more accomplishments of a user towards the user goal. The system also includes a categorization index component configured by the programming and the circuitry to index a plurality of documented events pertinent to the user goal, and a privacy operating standard component configured by the programming and the circuitry to assign privacy standard categories for posting the plurality of documented events. The system also includes a downloading communication stream component configured by the programming and the circuitry to receive downloaded content associated with the user goal from other documentation systems via a first real-time communications server, and an uploading communication stream component configured by the programming and the circuitry to post said content associated with the user goal to one or more external documentation systems via a second real-time communications server. The system also includes a search engine component configured by the programming and the circuitry to retrieve indexed results in response to a query. The components of the system can also include at least one or more of a family achievement system, an educational achievement system, a religious organizational achievement system, a musical achievement system, or an athletic achievement system.

1. A computer-implemented method of posting a plurality of events, the computer-implemented method comprising:
receiving through a communications interface of a processor from a user privacy parameters for a plurality of categories and a plurality of sub-categories of the plurality of events;
receiving through the communications interface a tagged first event having one or more categories and one or more sub-categories tagged with privacy parameters;
forwarding via circuitry the tagged first event to a first external documentation system;
receiving through the communications interface a downloaded second event from a second external documentation system;
tagging via the circuitry of the processor the downloaded second event with one or more categories and one or more sub-categories; and
posting via the circuitry of the processor at least one of the tagged first and second events according to the categories and the sub-categories, with the privacy parameters restricting accessibility of the posted first and second events.

2. The method of claim 1, wherein the tagging comprises:
identifying via the circuitry of the processor keywords from the downloaded second event;
comparing via the circuitry of the processor each identified keyword to the plurality of categories and the plurality of sub-categories;
determining a match between the one or more keywords and the one or more categories and the one or more sub-categories; and
tagging the second event with the matched one or more categories and the matched one or more sub-categories.

3. The method of claim 2, wherein the first and second events include ranked documented accomplishments for an individual, group, school, or organization.

4. The method of claim 3, wherein the ranked documented accomplishments include one or more of exceeding an established record, a public presentation of an award, a certificate of completion, a completed course of study, a publicized promotion, a completed sale of a product or service, a level of publicly received funds, or winning a publicly-awarded prize.

5. The method of claim 4, wherein the tagging comprises receiving from the user a privacy-right designation for the second event.

6. The method of claim 3, further comprising:
archiving via a storage database the ranked documented accomplishments by one or more of date, subject matter, organization, activity, and genre.

7. The method of claim 1, wherein the first external documentation system includes an event blog with the tagged first event.

8. The method of claim 7, wherein the received downloaded second event is posted to the event blog.

9. The method of claim 8, wherein the received downloaded second event is received from a different individual, group, school, or organization associated with the tagged first event.

10. A computerized achievement-posting system for registrants, comprising:
a registration component configured by programming and circuitry to receive registrations from the registrants and to allow data to be received from a plurality of external documentation systems;
a goal component configured by the programming and the circuitry to receive a user goal;
a measurement component configured by the programming and the circuitry to record one or more accomplishments of a user towards the user goal;
a milestone component configured by the programming and the circuitry to display the recorded one or more accomplishments of the user;
a support component configured by the programming and the circuitry to download incoming content from the registrants in support of the displayed and recorded one or more accomplishments;
a tagging component configured by the programming and the circuitry to tag the incoming content according to pre-established privacy parameters; and
an achievement component configured by the programming and the circuitry to upload and post said content in conjunction with completion of the user goal.

11. The system of claim 10, further comprising:
a challenge component configured by the programming and the circuitry to receive a challenge from one or more of the registrants to meet a new goal or exceed an existing goal of the user.

12. The system of claim 10, further comprising:
a challenge component configured by the programming and the circuitry to solicit a challenge from the user to one or more of the registrants to participate in achieving a new goal or exceeding an existing goal.

13. The system of claim 10, further comprising:
a coaching component configured by the programming and the circuitry to provide input, advice, and encouragement from the user to one or more of the registrants in achieving their defined goals.

14. The system of claim 10, further comprising:
a coaching component configured by the programming and the circuitry to post a request from the user to one or more of the registrants for coaching assistance in achieving a user-defined goal.

15. The system of claim 10, wherein at least one of the registrant or the user comprises a group of individuals.

16. The system of claim 10, wherein the downloaded incoming content of the support component includes a chat session.

17. The system of claim 10, further comprising:
a point-award component configured by the programming and the circuitry to award one or more points to the one or more accomplishments and to the user goal.

18. The system of claim 10, further comprising:
an archive component configured by the programming and the circuitry to record, index, and archive content and documented achievements for subsequent reference.

19. A computerized achievement posting system comprising:
a goal component configured by programming and circuitry to receive a user goal;
a measurement component configured by the programming and the circuitry to record one or more accomplishments of a user towards the user goal;
a categorization index component configured by the programming and the circuitry to index a plurality of documented events pertinent to the user goal;
a privacy operating standard component configured by the programming and the circuitry to assign privacy standard categories for posting the plurality of documented events;
a downloading communication stream component configured by the programming and the circuitry to receive downloaded content associated with the user goal from other documentation systems via a first real-time communications server;
an uploading communication stream component configured by the programming and the circuitry to post said content associated with the user goal to one or more external documentation systems via a second real-time communications server; and
a search engine component configured by the programming and the circuitry to retrieve indexed results in response to a query.

20. The system of claim 19, wherein said components comprise at least one or more of a family achievement system, an educational achievement system, a religious organizational achievement system, a musical achievement system, or an athletic achievement system.
